(19) United States
(12) Patent Application Publication
(10) Pub. No.: US 2012/0204787 A1
(43) Pub. Date: Aug. 16, 2012

(54) DOUBLE-SIDED COATING APPARATUS

(76) Inventors: Masaomi Nakahata, Kamakura-shi (JP); Ikuo Uematsu, Yokohama-shi (JP); Hideaki Morishima, Kashiwazaki-shi (JP)

(21) Appl. No.: 13/370,871

(22) Filed: Feb. 10, 2012

(30) Foreign Application Priority Data
Feb. 14, 2011 (JP) 2011-028659

(51) Int. Cl. B05C 11/02

(52) U.S. Cl. 118/118

(57) ABSTRACT

According to one embodiment, a double-sided coating apparatus includes a transport mechanism configured to convey the substrate, a first coating head disposed on one surface side of the substrate and configured to apply the coating liquid to the coated and uncoated regions, a second coating head disposed on the other surface side of the substrate and configured to apply the coating liquid to the coated and uncoated regions, and a coating roll disposed on the one surface side of the substrate and near a position where the coating roll is opposed to the second coating head with the substrate therebetween and includes first rollers disposed on axially opposite portions, at least one second roller disposed between the first rollers, and a rotation mechanism configured to rotate the first and second rollers such that the peripheral speed of the first rollers is higher than that of the second roller.

### CROSS-REFERENCE TO RELATED APPLICATIONS

This application is based upon and claims the benefit of priority from prior Japanese Patent Application No. 2011-028659, filed Feb. 14, 2011, the entire contents of which are incorporated herein by reference.

### FIELD

Embodiments described herein relate generally to a double-sided coating apparatus used in a process for simultaneously applying an electrolyte to both surfaces of a metal foil and other processes.

### BACKGROUND

In the manufacture of a lithium secondary battery, for example, sequential coating is performed such that a coating liquid, e.g., an electrolyte, is applied to each surface of a substrate, such as an aluminum foil, by means of a coating head. In the sequential coating, the surface of the substrate to be coated and its opposite surface are held by means of backup rolls as the substrate is fed, only one of the surfaces is temporarily coated, and the other surface is then coated after drying.

A double-sided coating apparatus is also known such that its throughput is improved by simultaneously coating both surfaces of a substrate. For example, the substrate is delivered horizontally, and a coating liquid is applied to both surfaces of the substrate. Since the coating liquid will adhere to rolls if the rolls contact coated areas of the substrate, the substrate is carried directly into a drying oven without using rolls. However, the substrate not being supported by rolls when this is done, its positional accuracy is degraded and transverse profile pulsation occurs.

Accordingly, the object of the present invention is to provide a double-sided coating apparatus capable of suppressing crosswise pulsation of a substrate to achieve satisfactory simultaneous double-sided coating.

### BRIEF DESCRIPTION OF THE DRAWINGS

FIG. 1A is an explanatory diagram schematically showing a double-sided coating apparatus according to a first embodiment;

FIG. 1B is an explanatory diagram illustrating a widthwise direction of a substrate for which the double-sided coating apparatus performs coating;

FIG. 2 is a perspective view schematically showing a coating roll incorporated in the double-sided coating apparatus;

FIG. 3 is a perspective view schematically showing another coating roll incorporated in the double-sided coating apparatus;

FIG. 4 is a perspective view schematically showing still another coating roll incorporated in the double-sided coating apparatus;

FIG. 5 is a perspective view schematically showing a further coating roll incorporated in the double-sided coating apparatus;

FIG. 6 is an explanatory diagram schematically showing a double-sided coating apparatus according to a second embodiment;

FIG. 7 is an explanatory diagram schematically showing a double-sided coating apparatus according to a third embodiment; and

FIG. 8 is an explanatory diagram schematically showing a double-sided coating apparatus according to a fourth embodiment.

### DETAILED DESCRIPTION

In general, according to one embodiment that applies a coating liquid to coated areas of the opposite surfaces of a sheet-like substrate having the coated areas and uncoated areas, including a transport mechanism configured to convey the substrate in a delivery direction; a first coating head disposed on one surface side of the substrate and configured to apply the coating liquid to the coated and uncoated regions alternately arranged in a direction transverse to the delivery direction; a second coating head disposed on the other surface side of the substrate and configured to apply the coating liquid to the coated and uncoated regions alternately arranged in the direction transverse to the delivery direction; and a coating roll disposed on the one surface side of the substrate and near a position where the coating roll is opposed to the second coating head with the substrate therebetween and comprising first rollers disposed on axially opposite portions, a second roller disposed between the first rollers, and a rotation mechanism configured to rotate the first and second rollers such that the peripheral speed of the first rollers is higher than that of the second roller.

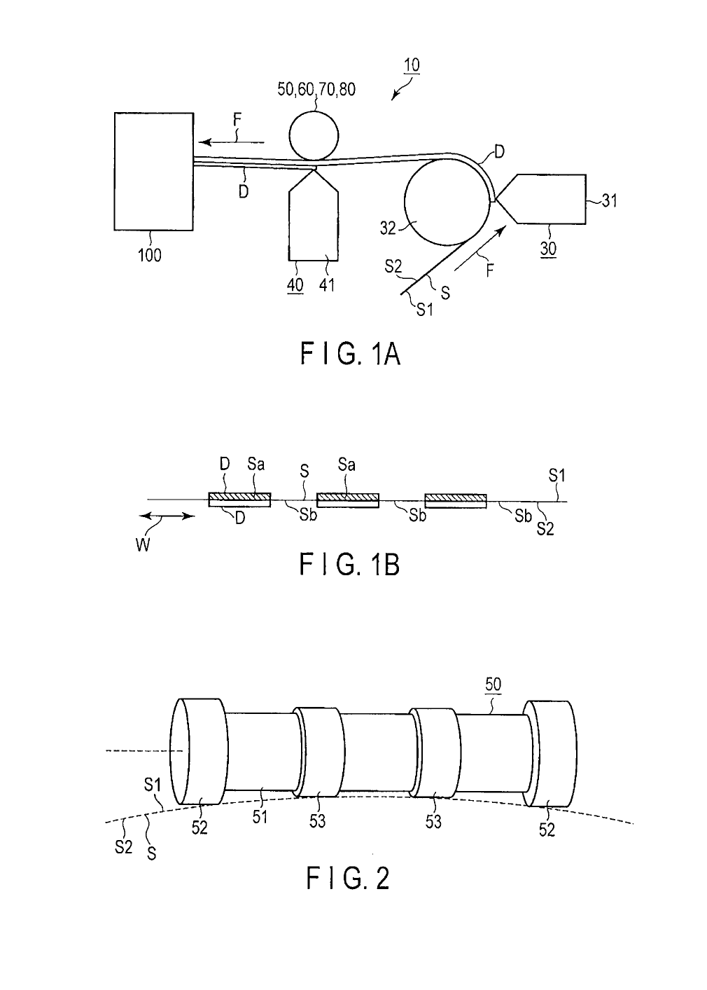

FIG. 1A is an explanatory diagram schematically showing a double-sided coating apparatus 10 according to a first embodiment, FIG. 1B is an explanatory diagram illustrating a widthwise direction of a substrate for which the double-sided coating apparatus performs coating; and FIG. 2 is a perspective view schematically showing a coating roll 50 incorporated in the coating apparatus 10. In FIG. 1A, letters S and D designate a sheet-like substrate, such as an aluminum foil, and a coating liquid, such as an electrolyte, respectively. In FIG. 1B, substrate S comprises coated areas Sa to which coating liquid D is applied and uncoated areas Sb free from the coating liquid. Coated and uncoated areas Sa and Sb are alternately arranged in transverse direction W (perpendicular to delivery direction F) of substrate S.

The double-sided coating apparatus 10 comprises a delivery mechanism (transport mechanism) 20 configured to deliver substrate S in a predetermined delivery direction, first coating unit 30 disposed downstream relative to the delivery mechanism 20, second coating unit 40, and dryer 100.

The first coating unit 30 comprises a first coating head 31 on the side of obverse surface S1 of substrate S and a backup roll 32 disposed on the side of reverse surface S2 opposite to the first coating head 31. The backup roll 32 is in the form of a circular cylinder. Both the first coating head 31 and a second coating head 41 (described later) are conventional ones for single-sided coating.

The second coating unit 40 comprises the second coating head 41 on the side of reverse surface S2 of substrate S and the coating roll 50 disposed on the side of obverse surface S1 opposite to the second coating head 41.

The coating roll 50 comprises a columnar shaft (rotation mechanism) 51 formed integrally with first rollers 52 and second rollers 53. The first rollers 52 are large-diameter cylinders formed individually on the opposite end sides of the shaft 51 with respect to its axis (or the transverse direction of substrate S). The second rollers 53 are small-diameter cylinders formed on intermediate parts of the shaft 51. Since the first and second rollers 52 and 53 share the same axis of rotation, the second rollers 53 are recessed below the first rollers 52 with respect to substrate S. Thus, the coating roll 50 is in the shape of a barbell such that the surface of the coating roll 50 in contact with substrate S is interpolated. The first and second rollers 52 and 53 are located corresponding individually to the uncoated areas Sb to which coating liquid D is not applied. The shaft 51 rotates the first and second rollers 52 and 53 at the same rate of rotation. Thus, the peripheral speed of the first rollers 52 is higher than that of the second rollers 53.

In the double-sided coating apparatus 10 constructed in this manner, double-sided coating is performed in the following manner. Specifically, uncoated substrate S is fed in predetermined delivery direction F by the delivery mechanism 20. Then, in the first coating unit 30, coating liquid D is applied to obverse surface S1 of substrate S by the first coating head 31. When this is done, substrate S is uniformly transversely pressed by the backup roll 32, so that coating liquid D can be uniformly applied without transverse profile pulsation.

Subsequently, in the second coating unit 40, coating liquid D is applied to reverse surface S2 of substrate S by the second coating head 41. When this is done, substrate S is pressed toward the second coating head 41 by the coating roll 50. In this way, the distance between the second coating head 41 and substrate S is controlled with high accuracy. The coating roll 50 comprises the first and second rollers 52 and 53, which are integrally rotated by the shaft 51. Thus, the peripheral speed of the first rollers 52 is higher than that of the second rollers 53.

Accordingly, substrate S receives tensile force acting from the side of the second rollers 53 rotating at the lower peripheral speed to the side of the first rollers 52 rotating at the higher peripheral speed, that is, from the transverse center side to the transversely opposite end sides. Even when the rollers are not in contact with the entire transverse area of obverse surface S1 of substrate S, therefore, substrate S is prevented from being wrinkled, so that coating liquid D can be uniformly applied without transverse profile pulsation.

Substrate S, having its obverse and reverse surfaces S1 and S2 thus coated with coating liquid D, is introduced into the dryer 100 and dried therein, whereupon a coating process is completed.

In the double-sided coating apparatus 10 according to the present embodiment, as described above, the distance between the second coating head 41 and substrate S is controlled with high accuracy, and the transversely opposite ends of substrate S are subjected to tensile force. Thus, substrate S can be prevented from being wrinkled, so that coating liquid D can be uniformly applied to both obverse and reverse surfaces S1 and S2 without transverse profile pulsation.

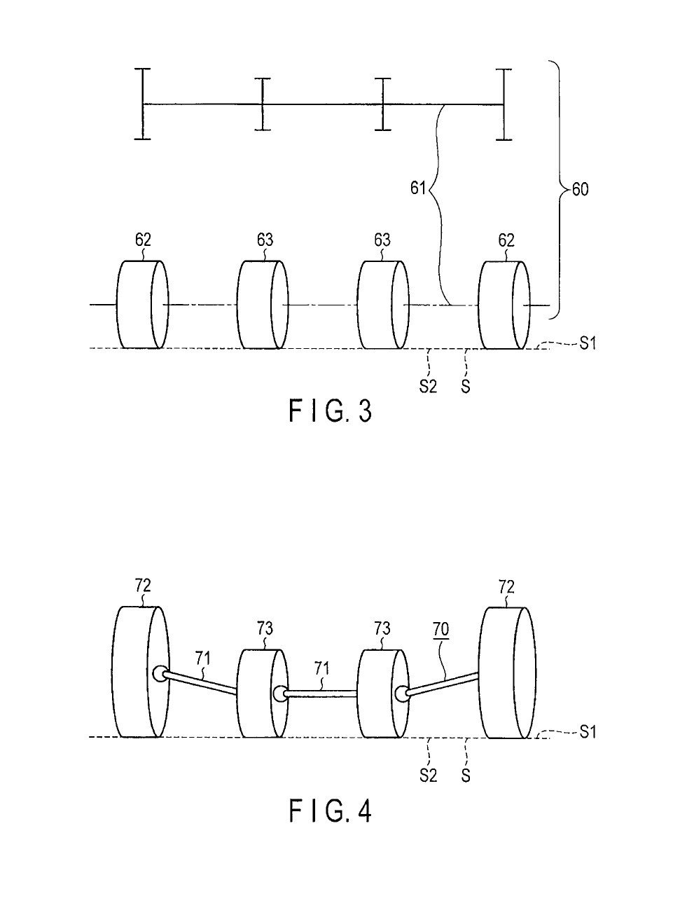

FIG. 3 is a perspective view schematically showing a coating roll 60 incorporated in the double-sided coating apparatus 10.

The coating roll 60 comprises a constant-velocity joint (rotation mechanism) 61 connected with first rollers 62 and second rollers 63. The first rollers 62 are large-diameter cylinders formed individually on the opposite end sides of the joint 61 with respect to its axial direction (or the transverse direction of substrate S). The second rollers 63 are small-diameter cylinders formed on intermediate parts of the joint 61. The first and second rollers 62 and 63 have their respective axes of rotation eccentric to each other and their substrate-side outer peripheral surfaces flush with each other. The joint 61 rotates the first and second rollers 62 and 63 at the same rate of rotation. Thus, the peripheral speed of the first rollers 62 is higher than that of the second rollers 63.

The coating roll 60 constructed in this manner can be used for coating in the same manner as the foregoing coating roll 50. Specifically, coating liquid D is applied to reverse surface S2 of substrate S by the second coating head 41 in the second coating unit 40.

Substrate S is pressed toward the second coating head 41 by the coating roll 60. The coating roll 60 comprises the first and second rollers 62 and 63, which are integrally rotated by the constant-velocity joint 61. Thus, the peripheral speed of the first rollers 62 is higher than that of the second rollers 63.

Accordingly, substrate S receives tensile force acting from the side of the second rollers 63 rotating at the lower peripheral speed to the side of the first rollers 62 rotating at the higher peripheral speed, that is, from the transverse center side to the transversely opposite end sides. Even when the rollers are not in contact with the entire transverse area of obverse surface S1 of substrate S, therefore, the distance between the second coating head 41 and substrate S can be accurately controlled, and substrate S is prevented from being wrinkled, so that coating liquid D can be uniformly applied without transverse profile pulsation.

As described above, the coating roll 60 can be used with the same effect obtained by means of the coating roll 50.

FIG. 4 is a perspective view schematically showing a coating roll 70 incorporated in the double-sided coating apparatus 10.

The coating roll 70 comprises a gear mechanism (rotation mechanism) 71 connected with first rollers 72 and second rollers 73 of the same diameter. The first rollers 72 are cylinders formed individually on the opposite end sides of the gear mechanism 71 with respect to its axial direction (or the transverse direction of substrate S). The second rollers 73 are cylinders formed on intermediate parts of the gear mechanism 71. The first and second rollers 72 and 73 have their substrate-side outer peripheral surfaces flush with each other. The gear mechanism 71 rotates the first rollers 72 at a rate of rotation higher than that of the second rollers 73. Thus, the peripheral speed of the first rollers 72 is higher than that of the second rollers 73.

The coating roll 70 constructed in this manner can be used for coating in the same manner as the foregoing coating roll 50. Specifically, coating liquid D is applied to reverse surface S2 of substrate S by the second coating head 41 in the second coating unit 40.

Substrate S is pressed toward the second coating head 41 by the coating roll 70. The coating roll 70 comprises the first and second rollers 72 and 73, which are rotated with a difference in rate of rotation by the gear mechanism 71. Thus, the peripheral speed of the first rollers 72 is higher than that of the second rollers 73.

Accordingly, substrate S receives tensile force acting from the side of the second rollers 73 rotating at the lower peripheral speed to the side of the first rollers 72 rotating at the higher peripheral speed, that is, from the transverse center side to the transversely opposite end sides. Even when the rollers are not in contact with the entire transverse area of obverse surface S1 of substrate S, therefore, the distance between the second coating head 41 and substrate S can be accurately controlled, and substrate S is prevented from being wrinkled, so that coating liquid D can be uniformly applied without transverse profile pulsation.

As described above, the coating roll 70 can be used with the same effect obtained by means of the coating roll 50.

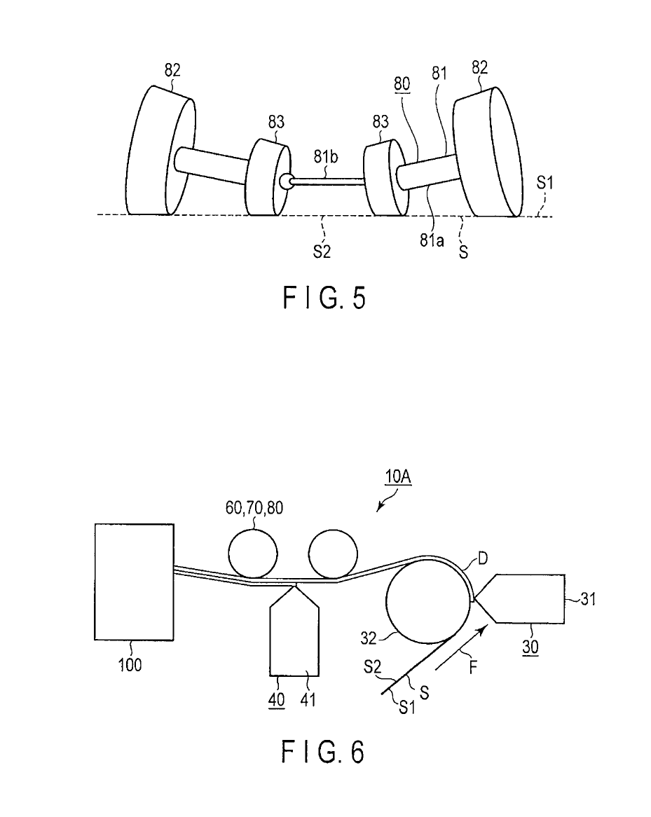

FIG. 5 is a perspective view schematically showing a coating roll 80 incorporated in the double-sided coating apparatus 10.

The coating roll 80 comprises a rotation mechanism 81. The rotation mechanism 81 comprises shafts 81a, constant-velocity joint 81b, a pair of first rollers 82, and a pair of second rollers 83. The first rollers 82 are frustums of large-basal-diameter cones formed individually on the opposite end sides of the rotation mechanism 81 with respect to its axial direction (or the transverse direction of substrate S). The second rollers 83 are frustums of small-basal-diameter cones formed on intermediate parts of the rotation mechanism 81. The first and second rollers 82 and 83 are connected to one another by the shafts 81a. The pair of second rollers 83 are connected to each other by the constant-velocity joint 81b.

The first and second rollers 82 and 83 are located corresponding individually to the uncoated areas Sb to which coating liquid D is not applied. The shafts 81a and constant-velocity joint 81b rotate all of the first and second rollers 82 and 83 at the same rate of rotation. Thus, the peripheral speed of the first rollers 82 is higher than that of the second rollers 83.

The coating roll 80 constructed in this manner can be used for coating in the same manner as the foregoing coating roll 50. Specifically, coating liquid D is applied to reverse surface S2 of substrate S by the second coating head 41 in the second coating unit 40.

Substrate S is pressed toward the second coating head 41 by the coating roll 80. The coating roll 80 comprises the first and second rollers 82 and 83, which are rotated at the same rate of rotation by the rotation mechanism 81. Thus, the peripheral speed of the first rollers 82 is higher than that of the second rollers 83.

Accordingly, substrate S receives tensile force acting from the side of the second rollers 83 rotating at the lower peripheral speed to the side of the first rollers 82 rotating at the higher peripheral speed, that is, from the transverse center side to the transversely opposite end sides. Even when the rollers are not in contact with the entire transverse area of obverse surface S1 of substrate S, therefore, the distance between the second coating head 41 and substrate S can be accurately controlled, and substrate S is prevented from being wrinkled, so that coating liquid D can be uniformly applied without transverse profile pulsation.

As described above, the coating roll 80 can be used with the same effect obtained by means of the coating roll 50.

FIG. 6 is an explanatory diagram schematically showing a double-sided coating apparatus 10A according to a second embodiment. In FIG. 6, like reference numbers are used to designate portions having the same functions as in FIG. 1A, and a detailed description is omitted.

In the double-sided coating apparatus 10A, the coating rolls 60, 70 or 80 are located ahead of and behind the second coating head 41, not opposite the head. Also in this arrangement, the coating rolls 60, 70 or 80 can function as backups for substrate S and produce tensile force acting from the transverse center side to the transversely opposite end sides in substrate S. Even when the rollers are not in contact with the entire transverse area of obverse surface S1 of substrate S, therefore, the distance between the second coating head 41 and substrate S can be accurately controlled, and substrate S is prevented from being wrinkled, so that coating liquid D can be uniformly applied without transverse profile pulsation.

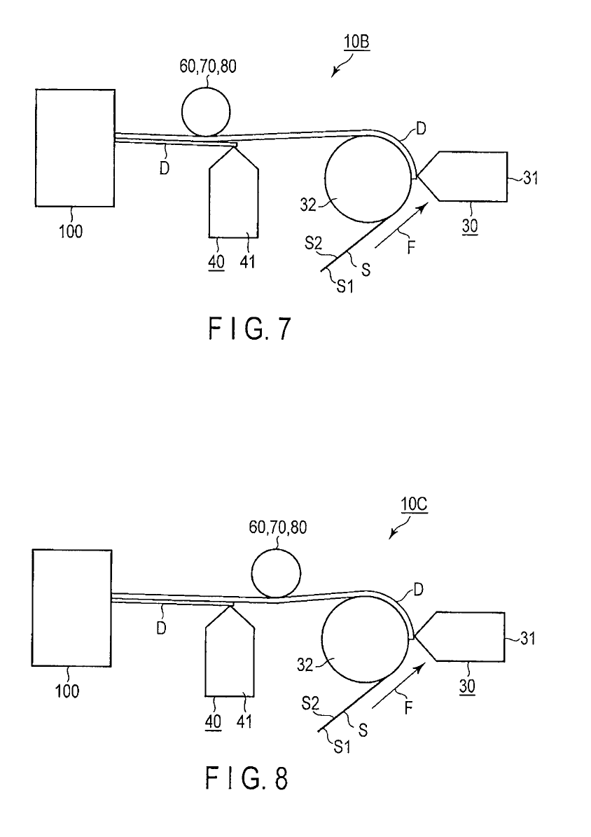

FIG. 7 is an explanatory diagram schematically showing a double-sided coating apparatus 10B according to a third embodiment. In FIG. 7, like reference numbers are used to designate portions having the same functions as in FIG. 1A, and a detailed description is omitted.

In the double-sided coating apparatus 10B, the coating roll 60, 70 or 80 is located behind the second coating head 41 along the course of travel of substrate S, not opposite the head. Also in this arrangement, the coating roll 60, 70 or 80 can function as a backup for substrate S and produce tensile force acting from the transverse center side to the transversely opposite end sides in substrate S. Even when the rollers are not in contact with the entire transverse area of obverse surface S1 of substrate S, therefore, the distance between the second coating head 41 and substrate S can be accurately controlled, and substrate S is prevented from being wrinkled, so that coating liquid D can be uniformly applied without transverse profile pulsation.

FIG. 8 is an explanatory diagram schematically showing a double-sided coating apparatus 100 according to a fourth embodiment. In FIG. 8, like reference numbers are used to designate portions having the same functions as in FIG. 1A, and a detailed description is omitted.

In the double-sided coating apparatus 100, the coating roll 60, 70 or 80 is located ahead of the second coating head 41 along the course of travel of substrate S, not opposite the head. Also in this arrangement, the coating roll 60, 70 or 80 can function as a backup for substrate S and produce tensile force acting from the transverse center side to the transversely opposite end sides in substrate S. Even when the rollers are not in contact with the entire transverse area of obverse surface S1 of substrate S, therefore, the distance between the second coating head 41 and substrate S can be accurately controlled, and substrate S is prevented from being wrinkled, so that coating liquid D can be uniformly applied without transverse profile pulsation.

While certain embodiments have been described, these embodiments have been presented by way of example only, and are not intended to limit the scope of the invention. Indeed, the novel embodiments described herein may be embodied in a variety of other forms. Furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A double-sided coating apparatus which applies a coating liquid to coated areas of the opposite surfaces of a sheet-like substrate having the coated areas and uncoated areas, comprising:
a transport mechanism configured to convey the substrate in a delivery direction;
a first coating head disposed on one surface side of the substrate and configured to apply the coating liquid to the coated and uncoated regions alternately arranged in a direction transverse to the delivery direction;
a second coating head disposed on the other surface side of the substrate and configured to apply the coating liquid to the coated and uncoated regions alternately arranged in the direction transverse to the delivery direction; and
a coating roll disposed on the one surface side of the substrate and near a position where the coating roll is opposed to the second coating head with the substrate therebetween and comprising first rollers disposed on axially opposite portions, at least one second roller disposed between the first rollers, and a rotation mechanism configured to rotate the first and second rollers such that the peripheral speed of the first rollers is higher than that of the second roller.

2. The double-sided coating apparatus according to claim 1, wherein the first rollers of the coating roll are large-diameter cylinders, the second roller is a small-diameter cylinder, and the rotation mechanism is a shaft which integrally coaxially connects the first and second rollers.

3. The double-sided coating apparatus according to claim 1, wherein the first rollers of the coating roll have a large diameter, the second roller has a small diameter, and the rotation mechanism rotates the first and second rollers at the same rate of rotation.

4. The double-sided coating apparatus according to claim 1, wherein the first and second rollers of the coating roll have the same diameter, and the rotation mechanism rotates the first rollers at a rate of rotation higher than that of the second roller.

5. The double-sided coating apparatus according to claim 1, wherein the first and second rollers of the coating roll are frustums of large-basal-diameter cones, the second roller is a frustum of a small-basal-diameter cone, and the rotation mechanism rotates the first and second rollers at the same rate of rotation.
